(19) United States
(12) Patent Application Publication
(10) Pub. No.: US 2026/0006483 A1
(43) Pub. Date: Jan. 1, 2026

(54) COMMUNICATION METHOD AND APPARATUS, ELECTRONIC DEVICE, AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 18/881,266

(22) PCT Filed: Jul. 5, 2022
(86) PCT No.: PCT/CN2022/103960

§ 371 Date: Jan. 4, 2025

(51) Int. Cl. H04W 28/02

(52) U.S. Cl. CPC H04W 28/0221; H04W 28/0236

(57) ABSTRACT

Embodiments of the present disclosure relate to the technical field of mobile communications, and provide a communication method and apparatus, an electronic device, and a storage medium. The communication method is applied to a multi-link station device (Non-AP STA). The method comprises: a Non-AP STA obtains a first transmit opportunity (TXOP) under a first link of a non-simultaneous transmit and receive (NSTR) link pair, and when the first TXOP overlaps restricted target wake time service periods (rTWT SPs) of the NSTR link, executes a random backoff mechanism under the first link. The embodiments of the present disclosure provide an implementation mode of an rTWT mechanism in an NSTR scenario.

### CROSS-REFERENCE TO RELATED APPLICATION

The present application is a national phase application of International Application No. PCT/CN2022/103960, filed on Jul. 5, 2022, the disclosure of which is incorporated herein by reference in its entirety for all purposes.

### TECHNICAL FIELD

The present disclosure relates to the field of mobile communication technology. Specifically, the embodiments of the present disclosure relate to a communication method and apparatus, an electronic device, and a storage medium.

### BACKGROUND

With the rapid development of mobile communication technology, Wireless Fidelity (Wi-Fi) technology has made great progress in transmission rate and throughput. At present, the research content of Wi-Fi technology includes 320 Mhz bandwidth transmission, aggregation and coordination of multiple frequency bands, etc. Its main application scenarios include video transmission, augmented reality (AR), virtual reality (VR), etc.

Specifically, the aggregation and coordination of multiple frequency bands means that devices can communicate with each other at 2.4 GHz, 5.8 GHz, 6 GHz and other frequency bands at the same time. For the scenario where devices communicate with each other at multiple frequency bands at the same time, a new media access control (MAC) mechanism needs to be defined for management. In addition, the aggregation and coordination of multiple frequency bands is expected to support low-latency transmission.

At present, the maximum bandwidth supported by multi-band aggregation and collaboration technology is 320 MHz (160 MHz+160 MHz). In addition, it may also support 240 MHz (160 MHz+80 MHz) and other bandwidths supported by existing standards.

In the Wi-Fi technology currently under study, a restricted Target wake time (rTWT) mechanism will be used to transmit low-latency services to distinguish delay-sensitive traffic from other types of traffic.

It should be noted that, information disclosed in the above background portion is provided only for better understanding of the background of the present disclosure, and thus it may contain information that does not form the prior art known by those ordinary skilled in the art.

### SUMMARY

The embodiments of the present disclosure provide a communication method and apparatus, an electronic device, and a storage medium.

On the one hand, an embodiment of the present disclosure provides a communication method, which is applied to a multi-connection station device Non-AP STA, and the method includes:
performing a random backoff mechanism in a first connection of a non-simultaneous transmit and receive NSTR connection pair, in a case where the Non-AP STA obtaining a first transmission opportunity TXOP in the first connection and the first TXOP is overlapped with a restricted target wake time service period rTWT SP of the NSTR connection.

On the other hand, an embodiment of the present disclosure further provides an electronic device, wherein the electronic device is a multi-connection station device Non-AP STA, and the electronic device includes:
a processing module, configured to perform a random backoff mechanism in a first connection of a non-simultaneous transmit and receive NSTR connection pair, in a case where the Non-AP STA obtaining a first transmission opportunity TXOP in the first connection and the first TXOP is overlapped with a restricted target wake time service period rTWT SP of the NSTR connection.

On the other hand, an embodiment of the present disclosure further provides a communication device, which is applied to a multi-connection station device Non-AP STA, and the device includes:
a backoff processing module, configured to perform a random backoff mechanism in a first connection of a non-simultaneous transmit and receive NSTR connection pair, in a case where the Non-AP STA obtaining a first transmission opportunity TXOP in the first connection and the first TXOP is overlapped with a restricted target wake time service period rTWT SP of the NSTR connection.

The embodiments of the present disclosure also provide an electronic device, including a memory, a processor, and a computer program stored in the memory and executable on the processor, wherein when the program is executed by the processor, one or more methods described in the embodiments of the present disclosure are implemented.

The embodiments of the present disclosure further provide a computer-readable storage medium, on which a computer program is stored. When the computer program is executed by a processor, one or more of the methods described in the embodiments of the present disclosure are implemented.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. Obviously, the drawings in the following description are only some embodiments of the present disclosure. For those skilled in the art, other drawings can be obtained based on these drawings without creative effort.

FIG. 1 is a flow chart of a communication method according to an embodiment of the present disclosure;

FIG. 2 is a second flow chart of the communication method provided in an embodiment of the present disclosure;

FIG. 3 is a third flowchart of the communication method provided in an embodiment of the present disclosure;

FIG. 4 is a fourth flow chart of the communication method provided in an embodiment of the present disclosure;

FIG. 5 is a schematic diagram of a structure of an electronic device provided by an embodiment of the present disclosure; and

FIG. 6 is a second schematic diagram of the structure of the electronic device provided in the embodiment of the present disclosure.

### DETAILED DESCRIPTION

In the embodiments of the present disclosure, the term “and/or” describes the association relationship of associated objects, indicating that three relationships may exist. For example, A and/or B may represent three situations: A exists alone, A and B exist at the same time, and B exists alone. The character “/” generally indicates that the associated objects before and after are in an “or” relationship.

The term “plurality” in the embodiments of the present disclosure refers to two or more than two, and other quantifiers are similar thereto.

Exemplary embodiments will be described in detail herein, examples of which are shown in the accompanying drawings. Unless otherwise indicated, when the following description refers to the drawings, the same numbers in different drawings represent the same or similar elements. The embodiments described in the following exemplary embodiments do not represent all embodiments consistent with the present invention. Instead, they are merely examples of devices and methods consistent with some aspects of the present invention as detailed in the appended claims.

The terms used in this disclosure are for the purpose of describing specific embodiments only and are not intended to limit the disclosure. The singular forms “a”, “said” and “the” used in this disclosure and the appended claims are also intended to include plural forms unless the context clearly indicates otherwise. It should also be understood that the term “and/or” used herein refers to and includes any or all possible combinations of one or more associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at the time of” or “when” or “in response to determining”.

Hereinafter, the technical solutions in the embodiments of the present disclosure will be described clearly and completely with reference to the drawings in the embodiments of the present disclosure. Obviously, the described embodiments are only part of the embodiments of the present disclosure, not all of the embodiments. Based on the embodiments in the present disclosure, all other embodiments obtained by those ordinary skilled in the art without creative effort are within the scope of protection of the present disclosure.

The embodiments of the present disclosure provide a communication method and apparatus, an electronic device, and a storage medium, so as to provide an implementation method of the rTWT mechanism in an NSTR scenario.

In the embodiments, the method and the device are based on the same application concept. Since the method and the device solve the problem in a similar principle, the implementation of the device and the method can refer to each other, and the repeated parts will be omitted.

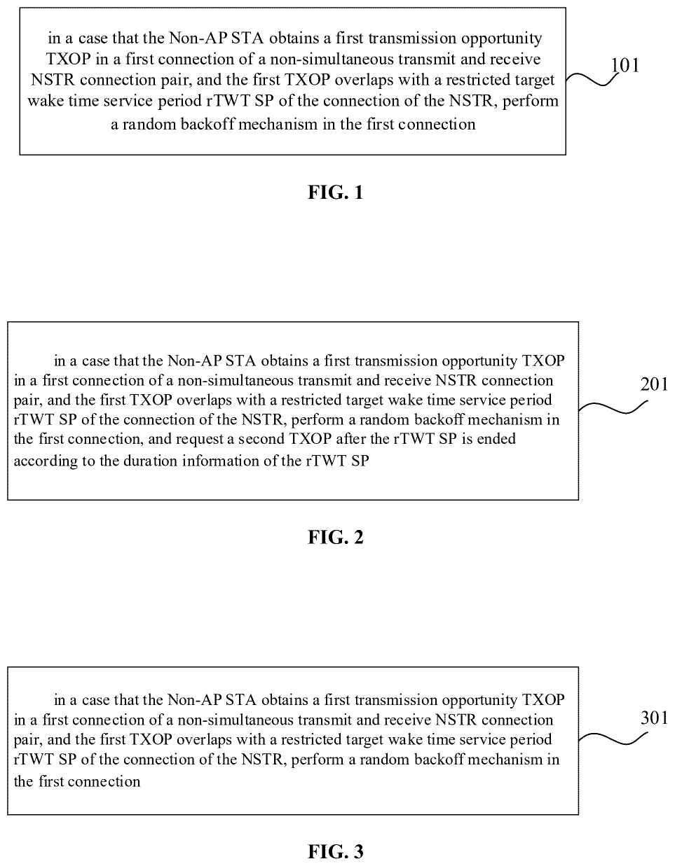

As shown in FIG. 1, an embodiment of the present disclosure provides a communication method. Optionally, the method may be applied to a multi-connection station device Non-AP STA. The method may include the following steps:
Step 101: in a case that the Non-AP STA obtains a first transmission opportunity TXOP in a first connection of a non-simultaneous transmit and receive NSTR connection pair, and the first TXOP overlaps with a restricted target wake time service period rTWT SP of the connection of the NSTR, perform a random backoff mechanism in the first connection.

In low-latency transmission scenarios, real-time data traffics of many applications have strict delay requirements, for example, the average delay or maximum delay is on the order of a few milliseconds to tens of milliseconds, and the applications require real-time data traffics to have extremely small jitter and strong reliability; while the rTWT mechanism allows the AP to use enhanced media access protection mechanism and resource reservation mechanism to provide more predictable delay, so that the AP can reduce the worst-case delay and/or reduce jitter to provide more reliable services; therefore, low-latency services, such as services with an average delay of less than 10 milliseconds, can be transmitted through the rTWT mechanism.

The rTWT mechanism allows the AP to use enhanced media access protection mechanisms and resource reservation mechanisms to provide more predictable delays, allowing the AP to reduce the worst-case delay and/or reduce jitter, and provide more reliable services. In the rTWT mechanism, the Non-AP STA needs to end its TXOP before the rTWT SP starts, or when the Non-AP STA does not belong to any rTWT SP and is not a TXOP responder, it needs to ensure sufficient time for frame interaction before the rTWT SP starts.

In the scenario of multi-connection communication, there is an NSTR operating mode; specifically, in the scenario of multi-connection (or link), a physical device can usually include multiple logical devices, each of which can independently manage data transmission and reception, and each logical device operates independently on one connection. However, due to the cost, energy saving and volume of the equipment, the anti-interference performance of the transceiver of some multi-connection devices is poor, and the transmission and reception of data between multiple connections will cause greater interference, resulting in that when the multi-connection device is sending data on one connection, it cannot receive data on other connections. These connections are referred to as NSTR connections.

In the disclosed embodiment, in the NSTR scenario, the NSTR includes a first connection and a second connection; the Non-AP STA obtains a first TXOP in the first connection, that is, the Non-AP STA is a TXOP holder; specifically, a TXOP refers to a bounded time period during which a STA can transmit a specific communication category, and the STA obtains the TXOP through competition. Once the TXOP is obtained, the STA can transmit frames of a specific communication category within the TXOP; wherein the frames can specifically be data frames, control frames, and management frames, etc. When a STA obtains a TXOP through channel competition, the STA is referred to as a transmission opportunity holder (TXOP holder). A STA sends a frame in a frame exchange sequence in response to a frame received from a TXOP holder, but the STA does not obtain a TXOP during this process, and the STA is referred to as a transmission opportunity responder (TXOP responder).

In the connection of the NSTR, the Non-AP STA obtains the first TXOP for transmitting non-low latency services in the first connection, and needs to transmit services with the AP with which the association has been established. The first TXOP overlaps with the rTWT SP of the connection of the NSTR, for example, overlaps with the rTWT SP of the first connection or overlaps with the rTWT SP of the second connection. At this time, the Non-AP STA performs a random backoff mechanism in the first connection; it can be understood that in the embodiment of the present disclosure, “overlap” refers to complete overlap or partial overlap in time.

Specifically, during the random backoff process, the Non-AP STA will delay access and use the exponential backoff algorithm to avoid conflicts, waiting until the rTWT SP ends before transmitting data again. Since the rTWT SP is used to transmit low latency services, when the first TXOP overlaps with the rTWT SP of the first connection or the rTWT SP of the second connection, it will affect the transmission of low latency services. Therefore, the Non-AP STA performs a random backoff mechanism in the first connection.

It can be understood that in the embodiment of the present disclosure, if a STA is a participant of the rTWT SP, it can access the channel within the time specified by the rTWT SP without considering the behavior of the STA in other NSTR connections, that is, as the STA participant of the rTWT SP, it can transmit low latency services normally; usually, in NSTR connections, rTWT SPs do not overlap in time and will not overlap with the rTWT SP of another connection in the NSTR connection pair.

In the embodiment of the present disclosure, when a Non-AP STA obtains a first transmission opportunity TXOP in the first connection of an NSTR connection pair, and the first TXOP overlaps with the rTWT SP of the connection of the NSTR, the Non-AP STA performs a random backoff mechanism in the first connection to ensure that the low-latency service is transmitted in the rTWT SP without interference and meets its latency requirements. The embodiment of the present disclosure provides an implementation method of the rTWT mechanism in an NSTR scenario.

Referring to FIG. 2, an embodiment of the present disclosure provides a communication method. Optionally, the method may be applied to a multi-connection station device Non-AP STA. The method may include the following steps:
Step 201, in a case that the Non-AP STA obtains a first transmission opportunity TXOP in a first connection of a non-simultaneous transmit and receive NSTR connection pair, and the first TXOP overlaps with a restricted target wake time service period rTWT SP of the connection of the NSTR,
perform a random backoff mechanism in the first connection, and request a second TXOP after the rTWT SP is ended according to the duration information of the rTWT SP.

In the embodiment, the Non-AP STA is a TXOP holder. In the NSTR scenario, the NSTR includes a first connection and a second connection. The Non-AP STA obtains a first TXOP for transmitting non-low latency services in the first connection, and needs to transmit a service with the associated AP. The first TXOP overlaps with the rTWT SP of the NSTR connection. At this time, the Non-AP STA performs a random backoff mechanism in the first connection. Specifically, the Non-AP STA requests a second TXOP after the end of the rTWT SP based on the duration information of the rTWT SP to delay access to avoid conflicts, and waits until the end of the rTWT SP to transmit data again to avoid affecting the transmission of low latency services within the TWT SP.

Referring to FIG. 3, an embodiment of the present disclosure provides a communication method. Optionally, the method may be applied to a multi-connection station device Non-AP STA. The method may include the following steps:
Step 301: in a case that the Non-AP STA obtains a first transmission opportunity TXOP in a first connection of a non-simultaneous transmit and receive NSTR connection pair, and the first TXOP overlaps with a restricted target wake time service period rTWT SP of the connection of the NSTR, perform a random backoff mechanism in the first connection;
wherein the Non-AP STA does not transmit data in the first TXOP if the rTWT SP is the rTWT SP of the first connection.

The Non-AP STA is the TXOP holder. In the NSTR scenario, the Non-AP STA obtains the first TXOP for transmitting non-low latency services in the first connection, and needs to transmit a service with the associated AP. The first TXOP overlaps with the subsequent rTWT SP of the first connection. At this time, the Non-AP STA executes a random backoff mechanism in the first connection and does not transmit data in the first TXOP to avoid affecting the transmission of low latency services in the TWT SP.

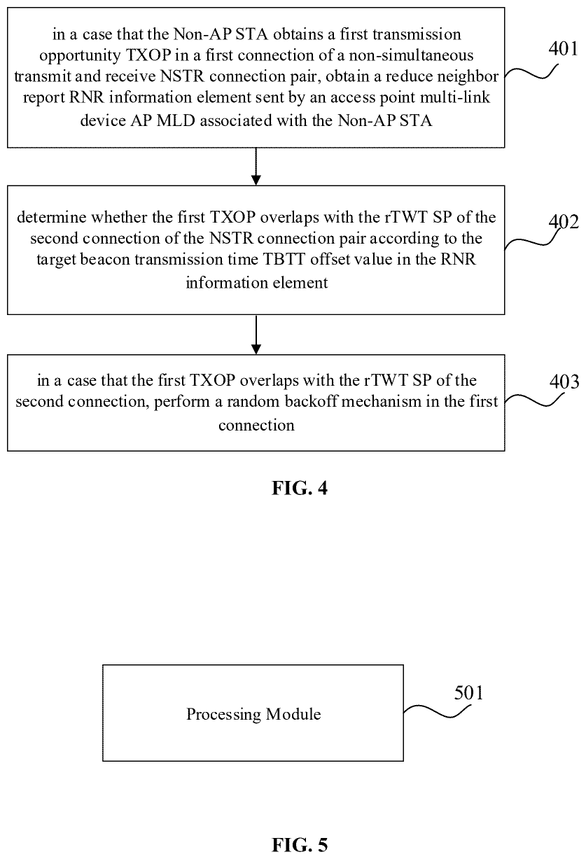

Referring to FIG. 4, an embodiment of the present disclosure provides a communication method. Optionally, the method may be applied to a multi-connected station device Non-AP STA. The method may include the following steps:
Step 401, in a case that the Non-AP STA obtains a first transmission opportunity TXOP in a first connection of a non-simultaneous transmit and receive NSTR connection pair, obtain a reduce neighbor report RNR information element sent by an access point multi-link device AP MLD associated with the Non-AP STA.

In the NSTR scenario, the NSTR includes a first connection and a second connection; when the Non-AP STA obtains the first TXOP in the first connection, it obtains a reduced neighbor report (RNR) information element sent by the AP MLD.

Step 402: determine whether the first TXOP overlaps with the rTWT SP of the second connection of the NSTR connection pair according to the target beacon transmission time TBTT offset value in the RNR information element.

The rTWT SP is a rTWT SP of the second connection of the NSTR, and the Non-AP STA determines whether the first TXOP overlaps with the rTWT SP according to the target beacon transmission time (TBTT) offset value in the RNR information element broadcast by the AP MLD.

Step 403: in a case that the first TXOP overlaps with the rTWT SP of the second connection, perform a random backoff mechanism in the first connection.

The first TXOP overlaps with the rTWT SP of the second connection of the NSTR. At this time, the Non-AP STA executes a random backoff mechanism in the first connection to avoid affecting the transmission of low latency service within the TWT SP of the second connection.

Optionally, in the embodiment of the present disclosure, the first TXOP being overlapped with the rTWT SP of the connection, including partial or full overlap between the time of the first TXOP and the rTWT SP, that is, the time period range of the first TXOP may fully or partially overlap with the time period range of the rTWT SP.

Optionally, in an embodiment of the present disclosure, the service transmitted by the first connection is not a low-latency service, that is, a non-low latency service.

In the embodiment of the present disclosure, when a Non-AP STA obtains a first transmission opportunity TXOP in the first connection of an NSTR connection pair, and the first TXOP overlaps with the rTWT SP of the connection of the NSTR, the Non-AP STA performs a random backoff mechanism in the first connection to ensure that the low-latency service is transmitted in the rTWT SP without interference and meets its latency requirements. The embodiment of the present disclosure provides an implementation method of the rTWT mechanism in an NSTR scenario.

Referring to FIG. 5, based on the same principle as the communication method provided in the embodiment of the present disclosure, the embodiment of the present disclosure further provides an electronic device, the electronic device is a multi-connection station device Non-AP STA, and the electronic device includes:
a processing module 501, configured to perform a random backoff mechanism in a first connection of a non-simultaneous transmit and receive NSTR, when the Non-AP STA obtains a first transmission opportunity TXOP in the first connection, and the first TXOP overlaps with the restricted target wake time service period rTWT SP of the connection of the NSTR.

In low-latency transmission scenarios, real-time data traffics of many applications have strict delay requirements, for example, the average delay or maximum delay is on the order of a few milliseconds to tens of milliseconds, and the applications require real-time data traffics to have extremely small jitter and strong reliability; while the rTWT mechanism allows the AP to use enhanced media access protection mechanism and resource reservation mechanism to provide more predictable delay, so that the AP can reduce the worst-case delay and/or reduce jitter to provide more reliable services; therefore, low-latency services, such as services with an average delay of less than 10 milliseconds, can be transmitted through the rTWT mechanism.

The rTWT mechanism allows the AP to use enhanced media access protection mechanisms and resource reservation mechanisms to provide more predictable delays, allowing the AP to reduce the worst-case delay and/or reduce jitter, and provide more reliable services. In the rTWT mechanism, the Non-AP STA needs to end its TXOP before the rTWT SP starts, or when the Non-AP STA does not belong to any rTWT SP and is not a TXOP responder, it needs to ensure sufficient time for frame interaction before the rTWT SP starts.

In the scenario of multi-connection communication, there is an NSTR operating mode; specifically, in the scenario of multi-connection (or link), a physical device can usually include multiple logical devices, each of which can independently manage data transmission and reception, and each logical device operates independently on one connection. However, due to the cost, energy saving and volume of the equipment, the anti-interference performance of the transceiver of some multi-connection devices is poor, and the transmission and reception of data between multiple connections will cause greater interference, resulting in that when the multi-connection device is sending data on one connection, it cannot receive data on other connections. These connections are referred to as NSTR connections.

In the disclosed embodiment, in the NSTR scenario, the NSTR includes a first connection and a second connection; the Non-AP STA obtains a first TXOP in the first connection, that is, the Non-AP STA is a TXOP holder; specifically, a TXOP refers to a bounded time period during which a STA can transmit a specific communication category, and the STA obtains the TXOP through competition. Once the TXOP is obtained, the STA can transmit frames of a specific communication category within the TXOP; wherein the frames can specifically be data frames, control frames, and management frames, etc. When a STA obtains a TXOP through channel competition, the STA is referred to as a transmission opportunity holder (TXOP holder). A STA sends a frame in a frame exchange sequence in response to a frame received from a TXOP holder, but the STA does not obtain a TXOP during this process, and the STA is referred to as a transmission opportunity responder (TXOP responder).

In the connection of the NSTR, the Non-AP STA obtains the first TXOP for transmitting non-low latency services in the first connection, and needs to transmit services with the AP with which the association has been established. The first TXOP overlaps with the rTWT SP of the connection of the NSTR, for example, overlaps with the rTWT SP of the first connection or overlaps with the rTWT SP of the second connection. At this time, the Non-AP STA performs a random backoff mechanism in the first connection; it can be understood that in the embodiment of the present disclosure, “overlap” refers to overlap in time.

Specifically, during the random backoff process, the Non-AP STA will delay access and use the exponential backoff algorithm to avoid conflicts, waiting until the rTWT SP ends before transmitting data again. Since the rTWT SP is used to transmit low latency services, when the first TXOP overlaps with the rTWT SP of the first connection or the rTWT SP of the second connection, it will affect the transmission of low latency services. Therefore, the Non-AP STA performs a random backoff mechanism in the first connection.

It can be understood that in the embodiment of the present disclosure, if a STA is a participant of the rTWT SP, it can access the channel within the time specified by the rTWT SP without considering the behavior of the STA in other NSTR connections, that is, as the STA participant of the rTWT SP, it can transmit low latency services normally; usually, in NSTR connections, rTWT SPs do not overlap in time and will not overlap with the rTWT SP of another connection in the NSTR connection pair.

Optionally, in the embodiment of the present disclosure, the processing module 501 includes:
a first processing sub module, configured to request a second TXOP after the rTWT SP is ended according to duration information of the rTWT SP.

Optionally, in the embodiment of the present disclosure, if the rTWT SP is the rTWT SP of the first connection, the Non-AP STA does not transmit data in the first TXOP.

Optionally, in the embodiment of the present disclosure, the electronic device further includes:
an obtaining module, configured to obtain, if the rTWT SP is the rTWT SP of the second connection of the NSTR, a reduce neighbor report RNR information element sent by an access point multi-link device AP MLD associated with the Non-AP STA; and
a determining module, configured to determine whether the first TXOP overlaps with the rTWT SP of the second connection according to the target beacon transmission time TBTT offset value in the RNR information element.

Optionally, in the embodiment of the present disclosure, the first TXOP overlaps with the connected rTWT SP, including partial or full time overlap between the first TXOP and the rTWT SP.

Optionally, in an embodiment of the present disclosure, the service transmitted by the first connection is a non-low-latency service.

In the disclosed embodiment, the processing module 501 obtains the first transmission opportunity TXOP in the first connection of the NSTR connection pair, and when the first TXOP overlaps with the rTWT SP of the connection of the NSTR, the Non-AP STA performs a random backoff mechanism in the first connection to ensure that the low-latency service is transmitted within the rTWT SP without interference and meets its latency requirements.

The embodiment of the present disclosure further provides a communication device, which is applied to a multi-connection station device Non-AP STA, and the device includes:
a backoff processing module, configured to perform a random backoff mechanism in a first connection of the non-simultaneous transmit and receive NSTR pair, when the Non-AP STA obtains a first transmission opportunity TXOP in the first connection, and the first TXOP overlaps with the restricted target wake time service period rTWT SP of the connection of the NSTR.

The device also includes other modules of the electronic device in the above-mentioned embodiment, which will not be described in detail here.

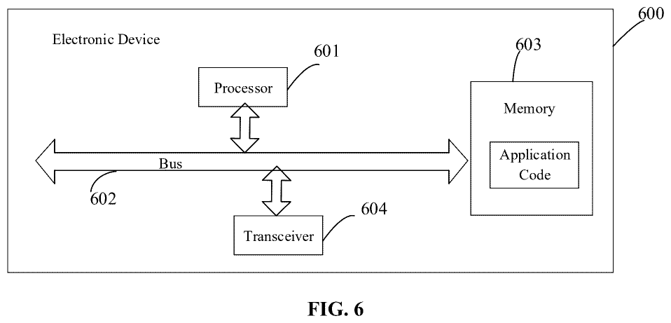

In an optional embodiment, the embodiment of the present disclosure further provides an electronic device, as shown in FIG. 6, the electronic device 600 shown in FIG. 6 may be a server, including: a processor 601 and a memory 603. The processor 601 and the memory 603 are connected, e.g., through a bus 602. Optionally, the electronic device 600 may further include a transceiver 604. It should be noted that in actual applications, the transceiver 604 is not limited to one, and the structure of the electronic device 600 does not constitute a limitation on the embodiment of the present disclosure.

The processor 601 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various exemplary logic blocks, modules and circuits described in conjunction with the disclosure of the present invention. The processor 601 may also be a combination that implements computing functions, such as a combination of one or more microprocessors, a combination of a DSP and a microprocessor, or the like.

The bus 602 may include a path for transmitting information between the above components. The bus 602 may be a PCI (Peripheral Component Interconnect) bus or an EISA (Extended Industry Standard Architecture) bus, or the like. The bus 602 may be divided into an address bus, a data bus, a control bus, and the like. For ease of representation, FIG. 6 only uses one thick line, but does not mean that there is only one bus or one type of bus.

The memory 603 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, or the like), a magnetic disk storage medium or other magnetic storage device, or any other medium that can be used to carry or store the desired program code in the form of instructions or data structures and can be accessed by a computer, but is not limited thereto.

The memory 603 is used to store application code for executing the solution of the present disclosure, and the execution is controlled by the processor 601. The processor 601 is used to execute the application code stored in the memory 603 to implement the content shown in the above method embodiment.

The electronic devices include, but are not limited to, mobile phones, laptop computers, digital broadcast receivers, PDAs (personal digital assistants), PADs (tablet computers), PMPs (portable multimedia players), vehicle-mounted terminals (such as vehicle-mounted navigation terminals), or the like, and fixed terminals such as digital TVs, desktop computers, etc. The electronic device shown in FIG. 6 is only an example and should not impose any limitation on the functions and scope of application of the embodiments of the present disclosure.

The embodiment of the present disclosure may be an independent physical server, or a server cluster or distributed system including multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, tablet computer, laptop computer, desktop computer, smart speaker, smart watch, or the like, but is not limited thereto. The terminal and the server may be directly or indirectly connected via wired or wireless communication, which is not limited by the present disclosure.

An embodiment of the present disclosure provides a computer-readable storage medium, on which a computer program is stored. When the computer-readable storage medium is run on a computer, the computer can execute the corresponding contents of the aforementioned method embodiment.

It should be understood that, although the steps in the flowchart of the accompanying drawings are displayed in sequence as indicated by the arrows, these steps are not necessarily executed in sequence in the order indicated by the arrows. Unless otherwise specified herein, there is no strict order restriction on the execution of these steps, and they can be executed in other orders. Moreover, at least a part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least a part of the sub-steps or stages of other steps.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, apparatus or device. In the present disclosure, a computer-readable signal medium may include a data signal propagated in a baseband or as part of a carrier wave, which carries a computer-readable program code. This propagated data signal may take a variety of forms, including but not limited to electromagnetic signals, optical signals, or any suitable combination of the above. The computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being installed in the electronic device.

The computer-readable medium carries one or more programs. When the one or more programs are executed by the electronic device, the electronic device executes the method shown in the above embodiment.

According to one aspect of the present disclosure, a computer program product or a computer program is provided, the computer program product or the computer program comprising computer instructions, the computer instructions being stored in a computer-readable storage medium. A processor of a computer device reads the computer instructions from the computer-readable storage medium, and the processor executes the computer instructions, so that the computer device executes the methods provided in the above-mentioned various optional implementations.

The computer program code for carrying out operations of the embodiment of the present disclosure may be written in one or more programming languages or a combination thereof, including object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In cases involving a remote computer, the remote computer may be connected to the user's computer through any type of network, including a local area network (LAN) or a wide area network (WAN), or may be connected to an external computer (e.g., via the Internet using an Internet service provider). The flow chart and block diagram in the accompanying drawings illustrate the possible architecture, function and operation of the system, method and computer program product according to various embodiments of the present disclosure. In this regard, each block in the flow chart or block diagram can represent a module, a program segment or a part of a code, and the module, the program segment or a part of the code contains one or more executable instructions for realizing the specified logical function. It should also be noted that in some implementations as alternatives, the functions marked in the block can also occur in a sequence different from that marked in the accompanying drawings. For example, two blocks represented in succession can actually be executed substantially in parallel, and they can sometimes be executed in the opposite order, depending on the functions involved. It should also be noted that each block in the block diagram and/or flow chart, and the combination of the blocks in the block diagram and/or flow chart can be implemented with a dedicated hardware-based system that performs a specified function or operation, or can be implemented with a combination of dedicated hardware and computer instructions.

The modules involved in the embodiments described in the present disclosure may be implemented by software or hardware. The name of a module does not limit the module itself in some cases. For example, module A may also be described as “module A for performing operation B”.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, a technical solution formed by replacing the above features with technical features with similar functions disclosed in this disclosure (but not limited to).

1. A communication method, comprising:
in response to obtaining, by a multi connection station device Non-AP STA, a first transmission opportunity (TXOP) in a first Non-simultaneous Transmit and Receive (NSTR) connection of a NSTR connection pair, and determining, by the Non-AP STA, that the first TXOP is overlapped with a restricted target wake time service period (rTWT SP) of a NSTR connection, performing, by the Non-AP STA, a random backoff mechanism in the first NSTR connection,
wherein the first NSTR connection is configured for the Non-AP STA to transmit and receive the NSTR connection pair non-simultaneously.

2. The communication method according to claim 1, wherein performing the random backoff mechanism in the first NSTR connection comprises:
requesting a second TXOP after the rTWT SP is ended according to duration information of the rTWT SP.

3. The communication method according to claim 1, further comprising:
in response to determining, by the Non-AP STA, that the rTWT SP is an rTWT SP of the first NSTR connection, determining, by the Non-AP STA, not to transmit data in the first TXOP.

4. The communication method according to claim 1, further comprising:
in response to determining, by the Non-AP STA, that the rTWT SP is an rTWT SP of a second NSTR connection, obtaining, by the Non-AP STA, that a reduce neighbor report (RNR) information element sent by an access point multi-link device (AP MLD) associated with the Non-AP STA; and
determining, by the Non-AP STA, whether the first TXOP is overlapped with the rTWT SP of the second NSTR connection according to a target beacon transmission time (TBTT) offset value in the RNR information element.

5. The communication method according to claim 1, wherein determining that the first TXOP is overlapped with the rTWT SP of the NSTR connection comprises:
determining that the first TXOP is partial or fully overlapped with the rTWT SP of the NSTR connection.

6. The communication method according to claim 1, wherein a service transmitted by the first NSTR connection is a non-low-latency service.

7-8. (canceled)

9. An electronic device, comprising a memory, a processor, and a computer program stored in the memory and executable on the processor, wherein when the program is executed by the processor, the electronic device performs a communication method, comprising:
in response to obtaining, by a multi connection station device Non-AP STA, a first TXOP in a first NSTR connection of a NSTR connection pair, and determining, by the Non-AP STA, that the first TXOP is overlapped with a rTWT SP of a NSTR connection, performing, by the Non-AP STA, a random backoff mechanism in the first NSTR connection,
wherein the first NSTR connection is configured for the Non-AP STA to transmit and receive the NSTR connection pair non-simultaneously.

10. A non-transitory computer-readable storage medium, on which a computer program is stored, wherein when the computer program is executed by a processor, the processor performs a communication method, comprising:
in response to obtaining, by a multi connection station device Non-AP STA, a first TXOP in a first NSTR connection of a NSTR connection pair, and determining, by the Non-AP STA, that the first TXOP is overlapped with a rTWT SP of a NSTR connection, performing, by the Non-AP STA, a random backoff mechanism in the first NSTR connection,
wherein the first NSTR connection is configured for the Non-AP STA to transmit and receive the NSTR connection pair non-simultaneously.

11. The electronic device according to claim 9, wherein performing the random backoff mechanism in the first NSTR connection comprises:
requesting a second TXOP after the rTWT SP is ended according to duration information of the rTWT SP.

12. The electronic device according to claim 9, wherein the communication method further comprises:
in response to determining, by the Non-AP STA, that the rTWT SP is an rTWT SP of the first NSTR connection, determining, by the Non-AP STA, not to transmit data in the first TXOP.

13. The electronic device according to claim 9, wherein the communication method further comprises:
in response to determining, by the Non-AP STA, that the rTWT SP is an rTWT SP of a second NSTR connection, obtaining, by the Non-AP STA, that a RNR information element sent by an AP MLD associated with the Non-AP STA; and
determining, by the Non-AP STA, whether the first TXOP is overlapped with the rTWT SP of the second NSTR connection according to a TBTT offset value in the RNR information element.

14. The electronic device according to claim 9, wherein determining that the first TXOP is overlapped with the rTWT SP of the NSTR connection comprises:
determining that the first TXOP is partial or fully overlapped with the rTWT SP of the NSTR connection.

15. The electronic device according to claim 9, wherein a service transmitted by the first NSTR connection is a non-low-latency service.

16. The non-transitory computer-readable storage medium according to claim 10, wherein performing the random backoff mechanism in the first NSTR connection comprises:
requesting a second TXOP after the rTWT SP is ended according to duration information of the rTWT SP.

17. The non-transitory computer-readable storage medium according to claim 10, wherein the communication method further comprises:
in response to determining, by the Non-AP STA, that the rTWT SP is an rTWT SP of the first NSTR connection, determining, by the Non-AP STA, not to transmit data in the first TXOP.

18. The non-transitory computer-readable storage medium according to claim 10, wherein the communication method further comprises:
in response to determining, by the Non-AP STA, that the rTWT SP is an rTWT SP of a second NSTR connection, obtaining, by the Non-AP STA, that a RNR information element sent by an AP MLD associated with the Non-AP STA; and
determining, by the Non-AP STA, whether the first TXOP is overlapped with the rTWT SP of the second NSTR connection according to a TBTT offset value in the RNR information element.

19. The non-transitory computer-readable storage medium according to claim 10, wherein determining that the first TXOP is overlapped with the rTWT SP of the NSTR connection comprises:
determining that the first TXOP is partial or fully overlapped with the rTWT SP of the NSTR connection.

20. The non-transitory computer-readable storage medium according to claim 10, wherein a service transmitted by the first NSTR connection is a non-low-latency service.
